(19) United States
(12) Patent Application Publication
(10) Pub. No.: US 2013/0342412 A1
(43) Pub. Date: Dec. 26, 2013

(54) ANTENNA FEEDHORN WITH ONE-PIECE FEEDCAP

(71) Applicants: Thomas JACKSON, Frederick, MD (US); Lawrence CRONISE, Spencerville, MD (US); Krishna Prakash HARI, Germantown, MD (US)

(72) Inventors: Thomas JACKSON, Frederick, MD (US); Lawrence CRONISE, Spencerville, MD (US); Krishna Prakash HARI, Germantown, MD (US)

(73) Assignee: Hughes Network Systems, LLC, Germantown, MD (US)

(21) Appl. No.: 13/528,440

(22) Filed: Jun. 20, 2012

(51) Int. Cl. H01Q 13/02; H01Q 15/16; H01P 11/00; H01Q 15/14

(52) U.S. Cl. 343/781 R; 343/784; 29/600

(57) ABSTRACT

An antenna for use with electromagnetic waves includes a waveguide body having an open end and first threads and a cap having second threads which interface with the first threads to press the cap against the open end. The cap includes a cover which covers the open end when the cap is screwed onto the open end using the first and second threads while allowing the electromagnetic waves to pass through the cover. The antenna can be a horn antenna, and can also be a feedhorn antenna used with a reflector in a reflector antenna.

### BACKGROUND OF THE INVENTION

In general, in order to transmit or receive signals included in electromagnetic waves, a transmitter and/or receiver is connected to an antenna. The antenna converts transmitted electrical signals into electromagnetic waves and received electromagnetic waves into electrical signals. There are many types of antennae depending on the use, such as vertical and dipole antennae. However, in order to improve the signal reception, such antennae can include a beam-forming element. One example of such a beam-forming element is a parabolic reflector which focuses the electromagnetic waves at a focal point.

Another type of antenna is a horn antenna. In general, the horn antenna is a flaring metal waveguide which directs electromagnetic waves in a beam. As such, the smaller end of the horn antenna is connected to transmission/reception electronics and the flared end is open. Horn antennas are used as directive antennas for such devices as radar guns, automatic door openers, microwave radiometers, as well as to calibrate gain in other antennas. Horn antennas are also useful to feed electromagnetic waves for larger antenna structures, such as parabolic antennas used for satellite communications, detection of signals from space, etc. In this context, the horn antenna is called a feedhorn antenna and is placed at or near the focal point of the parabolic reflector. The feedhorn antenna conveys electromagnetic waves between the transmitter and/or receiver and the reflector.

While a horn antenna can be used within a protective structure, when the horn antenna is located in an outdoor environment, there is a need to protect the horn portion of the antenna from environmental contamination. For instance, when mounted to a parabolic reflector as used in a satellite dish, the feedhorn antenna would necessarily be located in places where water, yard debris, and animals or insects could cause harm to the feedhorn antenna and degrade its performance. Therefore, the opening of the horn antenna needs to be closed.

The closure of the opening can be accomplished using epoxy to glue a cover to the opening, the cover can be press fit onto the horn antenna, or the cover could snap on to the opening. However, these methods still result in defective seals, such as where the epoxy is not sufficiently thick or the cover does not snap on or press fit securely. As such, the closure may be insufficient to prevent long term environmental damage in a real world environment.

### SUMMARY OF THE INVENTION

According an aspect of the invention, an antenna for use with electromagnetic waves includes a waveguide body having an open end and first threads; and a cap having second threads which interface with the first threads to press the cap against the open end, the cap comprising a cover which covers the open end when the cap is screwed onto the open end using the first and second threads while allowing the electromagnetic waves to pass through the cover.

According an aspect of the invention, a reflector antenna includes a reflector which receives the electromagnetic waves and focuses the received electromagnetic waves at a focal point; an antenna which includes a waveguide body having an open end and first threads and a cap having second threads which interface with the first threads to press the cap against the open end, the cap comprising a cover which covers the open end when the cap is screwed onto the open end using the first and second threads while allowing the electromagnetic waves to pass through the cover; and a feed support which supports the antenna relative to the reflector such that the electromagnetic waves are received at the open end after passing through the cover.

According an aspect of the invention, a method of assembling an antenna for use with electromagnetic waves includes aligning a waveguide body having an open end and first threads with a cap having second threads which interface with the first threads; and screwing the cap to the open end using the first and second threads until the cap is attached to the waveguide body and a cover of the cap covers the open end, wherein the cover is transparent to the electromagnetic waves.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram of a two-way satellite communication system according to an aspect of the invention;

FIG. 2 is a diagram of a parabolic reflector antenna according to an aspect of the invention;

FIG. 3 is a perspective view of a closed feedhorn antenna according to an aspect of the invention;

FIG. 4 is a perspective view of an open feedhorn antenna according to an aspect of the invention; and

FIG. 5 is a perspective view of a cap used to cover the open feedhorn antenna of FIG. 4 according to an aspect of the invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

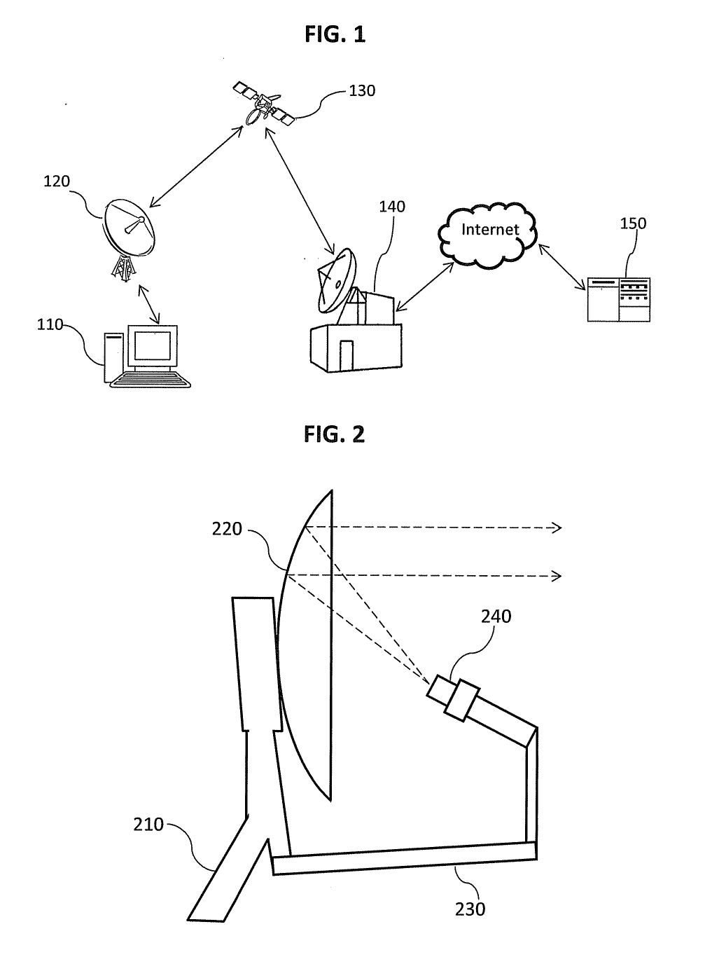

While not limited thereto, an embodiment of the invention shown in FIG. 1 will be described in relation to a satellite internet system which provides internet and two-way communication. Examples of such systems include the HughesNet in Ku-band, HughesNet in Ka-band, the Hughes Spaceway system, and the HughesNet Gen-4 system. However, it is understood that the invention is not limited thereto, and that aspects of the invention can be used for pure reception systems such as satellite television or radio. It is further understood that the invention is not limited to terrestrial-space interactions, and that aspects are useful for transmissions and/or reception between purely terrestrial systems, or between purely space systems.

As shown in the system of FIG. 1, a request for a web page is sent from a computer 110 to an orbiting satellite 130 using a satellite dish 120. While shown representationally as a home computer 110, it is understood that the computer 110 could be a tablet, a portable computer, a smartphone, a game system or other element which uses a processor and communicates over a network. Further, the connection between the satellite dish 120 and the computer 110 is not limited to any particular combination of network elements, and thus may include wired and/or wireless connections.

In the shown embodiment, the satellite 130 would be in geosynchronous orbit about 22,000 miles above the earth. However, it is understood that in other aspects, the orbiting satellite 130 could instead be in a non-geosynchronous orbit or at other altitudes, or could be an aircraft which relays ground signals between terrestrial stations. Moreover, while shown as a single satellite 130, it is understood that the satellite 130 could be part of a larger system of satellites which interact with each other to provide communication services.

The satellite 130 receives the request from the satellite dish 120 and transmits the request to the Network Operations Center (NOC) 140. The NOC 140 accesses the requested website on a server 150 via a network, such as the internet. The NOC 140 transmits the accessed website to the satellite 130, which in turn beams the website back to the computer 110 via the satellite dish 120. As such, while not limited thereto, the satellite internet system uses a satellite dish 120 which is capable of both transmission and reception.

FIG. 2 is a diagram of a parabolic reflector antenna according to an aspect of the invention. According to the embodiment shown in FIG. 2, the parabolic reflector antenna includes a dish 220 which is mounted to an object (such as a roof, the ground) using a mast 210. The mast 210 holds the dish 220 at a particular attitude and altitude to communicate with another object, such as the satellite 130 of FIG. 1. However, it is understood that the mast 210 need not be used in all aspects, such as where the dish 220 is directly connected to the stationary object, and can be in other mounting forms such as a trimast. It is also understood that the dish 220 could be made movable relative to the stationary object, such as where the dish 220 tracks a movable object with which it communicates such as an aircraft, or the dish 220 could be attached to an object in motion such as an aircraft, ship, or car.

While other shapes can be used in other aspects, the dish 220 has a parabolic shape designed to capture incoming electromagnetic waves. At substantially a focal point of the dish 220 is a feedhorn 240. The feedhorn 240 is a waveguide, usually shaped in the form of a cylindrical structure. The feedhorn 240 is supported relative to the dish 220 by a feed support 230. As shown, when transmitting (such as when there is a request for the website sent as in FIG. 1), the feedhorn 240 sends an electromagnetic wave as a divergent beam which is substantially collimated by the dish 220 to be directed at an object (such as the satellite 130 of FIG. 1). By way of example, the feedhorn 240 is connected to a transmitter and converts the radio frequency alternating current from the transmitter into radio waves to be transmitted. The converted waves are to the dish 220, which is shaped to focus the converted waves into a beam. As such, the sent signal experiences less loss during transmission. Conversely, when an electromagnetic wave is received at the dish 220, the received wave is focused on the feedhorn 240.

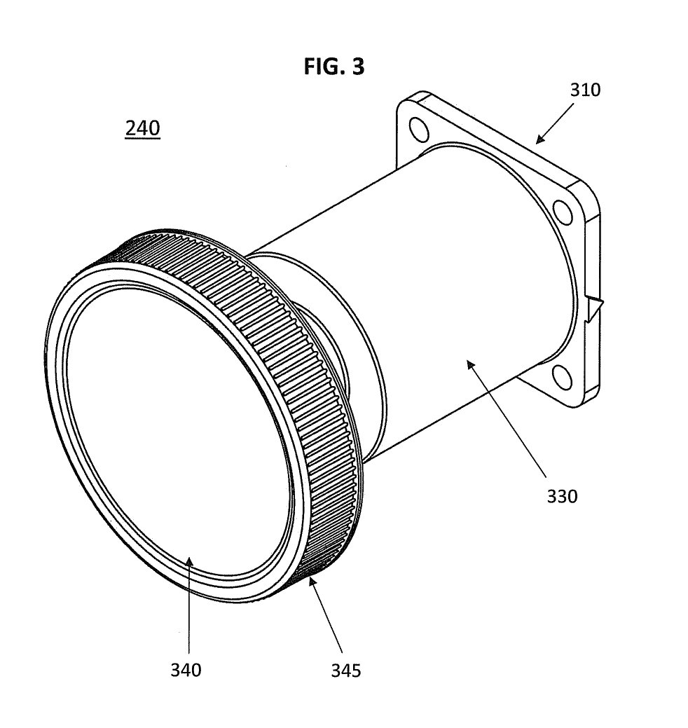

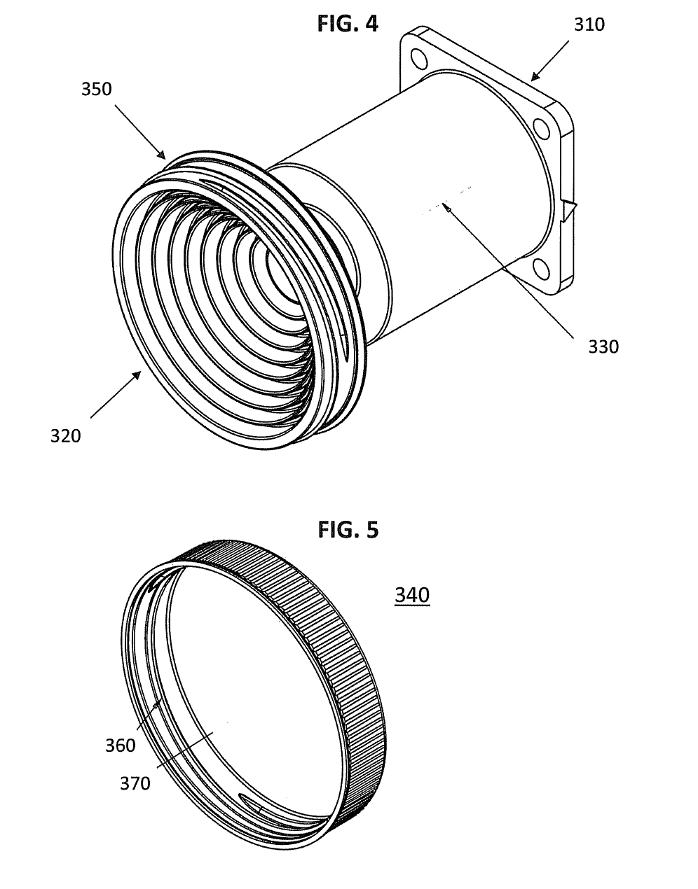

FIG. 3 is a perspective view of a closed feedhorn antenna 240 according to an aspect of the invention. FIG. 4 is a perspective view of an open feedhorn antenna according to an aspect of the invention. FIG. 5 is a perspective view of a cap used to cover the open feedhorn antenna of FIG. 4 according to an aspect of the invention. As shown in FIG. 3, the feedhorn 240 includes a mount 310. The mount 310 connects the feedhorn 240 to an object, such as the feed support 230 and/or to a signal conversion device (not shown). An example of the signal conversion device is a Low Noise Block Down Converter (LNB), which is a transducer that converts electromagnetic waves into electric signals usable by a connected piece of electronics, such as a television or the computer 110 of FIG. 1. Further, while not shown, a transmitter and/or receiver can be connected to the mount directly or via a cable to amplify signals passing between the feedhorn 240 and the electronics.

As shown in FIGS. 3-5, the feedhorn 240 includes a cylindrical waveguide portion 330 which extends from the mount 310 and terminates at a horn 320. While shown as cylindrical, it is understood that other shapes can be used for the portion 330 and/or horn 320, such as a rectangular cross section with a pyramidal horn or where the flare of the horn 320 is exponential as opposed to expanding at a substantially fixed rate.

A cap 340 covers the horn 320 in order to separate an interior of the horn 320 from the elements, such as by keeping moisture out of the horn 320. The cap 340 is transparent to the electromagnetic waves transmitted from or received at the horn 320. While not required in all aspects, the cap 340 can also be transparent to other spectra, such as visible light to allow inspection of the horn 320 when the cap 340 is installed. While not limited thereto, the cap 340 could be made of plastic, such as polypropylene or polycarbonate.

Further, the shown cap 340 has grips 345 to allow the cap 340 to be screwed onto the horn 320 using the threads 350, 360. In this way, when the cap 340 is screwed onto the horn 340, there is a compressive connection between the cap 340 and the horn 320 which is easy to create during manufacture without special equipment or delays, such as occur when using epoxy or press fitting. Such an arrangement also allows the cap 340 to be removed after assembly in aspects of the invention which is also not easily done when a cover is connected using an epoxy or press fitting. While not shown, it is understood that an additional seal could be used, such as a sealant at the threads 350, 360.

Additionally, while shown as having threads 350 at the exterior of the horn 320 and the threads 360 at the interior of the cap 340, it is understood that the threads 350, 360 can be otherwise disposed. For instance, the threads 350 could be at the interior of the horn 320 and the threads 360 on the exterior of the cap 340. As such, aspects of the invention are not limited to the location of the threads 350 relative to an interior or exterior of the horn 320.

Moreover, the location of the threads 350 relative to the end of the horn 320 can be varied. For instance, if the cap 340 edge was elongated, the threads 350 could be on the cylindrical waveguide portion 330 or at the mount 310. As such, aspects of the invention are not limited to the location of the threads 350 relative to an edge of the horn 320.

Also, while shown as helical threads 350, 360, it is understood that the threads 350, 360 need not be helical in shape, can have horizontal elements, need not be identical in shape and/or be other interlocking but complimentary members. While not limited thereto, the threads 350, 360 could interlock using a bayonet mount, by which one of the threads 350, 360 is a pin, and the other of the threads 350, 360 is an L-shaped slot which receives the pin in one direction as the cap 340 is connected and holds the cap 340 when the cap 340 is twisted in a second direction.

The cap 340 includes a cover 370 which separates the exterior environment from the interior of the horn 320. The cap 340 need not be of the same material as the horn 320, such as where the horn 320 is made of aluminum and the cap 340 is made of plastic, but the invention is not limited thereto. Further, the cover 370 could further be transparent to visible radiation, thereby allowing visible inspection of the horn 320. This transparency could be created by the cap 340 being made of a transparent plastic material, or through the cover 370 including a window portion.

While not required in all aspects, an edge of the horn 320 could include an O-ring groove which receives an O-ring to prevent a further seal to prevent any damage due to environmental factors. A matching O-ring could be installed in the cap 340, or could be separately placed on the horn 320. Such an O-ring would be made of a sealing material, such as a rubber or plastic, which would add a further layer of seal. However, the invention is not limited thereto.

According an aspect of the invention, when attaching the cap 340 to the horn 320, the threads 350 are aligned with the threads 360, and the cap 340 is screwed onto the horn 320 such that the cover 370 covers the horn 320. The attachment could occur during an inspection, in which case the cap 340 was unscrewed from the horn 320, or during manufacture. For instance, where an environmental test is performed during manufacture, the cap 340 could be left off to allow direct access to the horn 320. On completion, the cap 340 would be screwed onto the horn 320, and the feedhorn 240 could be attached to the feed support 230. However, it is understood that the invention is not limited to the particular time or order for connection of the cap 340 to the horn 240. It is understood that, while described in terms of attachment using a rotation screwing motion, the invention is not limited to any particular clockwise or counterclockwise direction or to a rotational motion as any connection would depend on the shape of the threads 350, 360.

While described in terms of a satellite dish, it is understood that the feedhorn antenna could be used in other situations, such as a horn antenna used without a parabolic reflector dish or where used as a feedhorn antenna in other shape reflectors. Moreover, while described in terms of prevent environmental contamination in the context of moisture, it is understood that the seal strength could be made to vary depending on the need, such as where the feedhorn would be used underwater or in space. In this context, the strength of the seal could be varied through adjustment of the number of threads 350, 360. Also, while shown as being solid, it is understood that the cap 370 could be made porous in other aspects, such as where moisture is less of a concern than foreign object debris.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An antenna for use with electromagnetic waves, the antenna comprising:
a waveguide body having an open end and first threads; and
a cap having second threads which interface with the first threads and which press the cap against the open end after the cap is screwed onto the open end using the first and second threads, the cap comprising a cover which covers the open end while allowing the electromagnetic waves to pass through the cover.

2. The antenna of claim 1, wherein the cap comprises an edge extending from the cover towards the open end, the edge comprising the second threads.

3. The antenna of claim 2, wherein:
the waveguide body has a first cross sectional area at a closed end, and a second cross sectional area at the open end which is larger than the first cross sectional area; and
the cover has a third cross sectional area, the third cross sectional area being at least as large as the second cross sectional area.

4. The antenna of claim 3, wherein the first, second, and third cross sectional areas are circular.

5. The antenna of claim 2, wherein the cover extends between the edge to define an interior space of the cap, and the first and second threads are within the interior space after the cap is screwed onto the open end.

6. The antenna of claim 5, wherein the cap further comprises grips at the edge, wherein the grips are not disposed in the interior space.

7. The antenna of claim 1, wherein the waveguide body comprises a first material, and the cap comprises a second material other than the first material.

8. The antenna of claim 7, wherein the first material is not transparent to the electromagnetic waves, and the second material is transparent to the electromagnetic waves.

9. The antenna of claim 7, wherein the second material is further optically transparent.

10. A horn antenna comprising the antenna of claim 1, wherein the waveguide body comprises a flared portion which terminates at the open end.

11. A reflector antenna comprising the antenna of claim 1, the reflector antenna comprising:
a reflector having a focal point at which received electromagnetic waves are focused; and
a feed support which supports the antenna relative to the reflector such that the electromagnetic waves are received at the cover.

12. The reflector antenna of claim 11, wherein the antenna further transmits the electromagnetic waves to the reflector through the cover, and the reflector reflects the transmitted electromagnetic waves as a beam.

13. The reflector antenna of claim 11, wherein the reflector comprises a parabolic reflector.

14. The reflector antenna of claim 11, wherein the cap comprises an edge extending from the cover towards the open end, the edge comprising the second threads.

15. The reflector antenna of claim 14, wherein:
the antenna further comprises a mount at which the feed support is connected to the waveguide body,
the waveguide has a first cross sectional area at a closed end at the mount, and a second cross sectional area at the open end which is larger than the first cross sectional area; and
the cover has a third cross sectional area, the third cross sectional area being at least as large as the second cross sectional area.

16. The reflector antenna of claim 15, wherein the first, second, and third cross sectional areas are circular.

17. The reflector antenna of claim 14, wherein the cover extends between the edge to define an interior space of the cap, and the first and second threads are within the interior space.

18. The reflector antenna of claim 14, wherein the waveguide body comprises a first material, and the cap comprises a second material other than the first material.

19. The reflector antenna of claim 18, wherein the first material is not transparent to the electromagnetic waves, and the second material is transparent to the electromagnetic waves.

20. A method of assembling an antenna for use with electromagnetic waves, the method comprising:
aligning a waveguide body having an open end and first threads with a cap having second threads which interface with the first threads; and
screwing the cap to the open end using the first and second threads until the cap is attached to the waveguide body and a cover of the cap covers the open end, wherein the cover is transparent to the electromagnetic waves.
